(19) United States
(12) Patent Application Publication
(10) Pub. No.: US 2026/0111282 A1
(43) Pub. Date: Apr. 23, 2026

(54) WORKLOAD AS A SERVICE IN CLOUD ENVIRONMENT

(71) Applicant: Dell Products L.P., Round Rock, TX (US)

(72) Inventors: Hong YUAN, Shanghai (CN); Shunhua XIE, Shanghai (CN); Minyan SHEN, Shanghai (CN)

(73) Assignee: Dell Products L.P., Round Rock, TX (US)

(21) Appl. No.: 18/943,107

(22) Filed: Nov. 11, 2024

(30) Foreign Application Priority Data
Oct. 18, 2024 (CN) 202411463554.5

(51) Int. Cl. G06F 9/50

(52) U.S. Cl. CPC G06F 9/505; G06F 9/5016; G06F 2209/5019; G06F 2209/508

(57) ABSTRACT

An information handling system may include at least one processor and a memory. The information handling system may be configured to receive a workload specification for a target information handling system, wherein the workload specification identifies target utilization levels for processor usage, memory usage, input/output (I/O) usage, and/or network usage of the target information handling system; deploy an initial set of one or more workload units to the target information handling system, wherein the one or more workload units are configured to cause an actual utilization level of processor, memory, I/O, and/or network resources on the target information handling system; and adjust the number of workload units deployed on the target information handling system in response to a mismatch between the target utilization levels and the actual utilization levels.

### TECHNICAL FIELD

The present disclosure relates in general to information handling systems, and more particularly to providing performance benchmarking and load testing in information handling systems.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Hyper-converged infrastructure (HCI) is an IT framework that combines and networking into a single system in an effort to reduce data center complexity and increase scalability. Hyper-converged platforms may include a hypervisor for virtualized computing, software-defined storage, and virtualized networking, and they typically run on standard, off-the-shelf servers. One type of HCI solution is the Dell EMC VxRail™ system. Some examples of HCI systems may operate in various environments (e.g., an HCI management system such as the VMware® vSphere® ESXi™ environment, or any other HCI management system). Some examples of HCI systems may operate as software-defined storage (SDS) cluster systems (e.g., an SDS cluster system such as the VMware® vSAN™ system, or any other SDS cluster system).

In the HCI context (as well as other contexts), information handling systems may execute virtual machines (VMs) for various purposes. A VM may generally comprise any program of executable instructions, or aggregation of programs of executable instructions, configured to execute a guest operating system on a hypervisor or host operating system in order to act through or in connection with the hypervisor/host operating system to manage and/or control the allocation and usage of hardware resources such as memory, central processing unit time, disk space, and input and output devices, and provide an interface between such hardware resources and application programs hosted by the guest operating system.

Regardless of whether an information is set up for VMs, bare metal operations, or normal host system operations, it is advantageous for a cloud service provider to be able to supply performance benchmarking and load testing services. Embodiments of this disclosure implement a “workload as a service” cloud platform.

It should be noted that the discussion of a technique in the Background section of this disclosure does not constitute an admission of prior-art status. No such admissions are made herein, unless clearly and unambiguously identified as such.

### SUMMARY

In accordance with the teachings of the present disclosure, the disadvantages and problems associated with benchmarking and load testing may be reduced or eliminated.

In accordance with embodiments of the present disclosure, an information handling system may include at least one processor and a memory. The information handling system may be configured to receive a workload specification for a target information handling system, wherein the workload specification identifies target utilization levels 10 for processor usage, memory usage, input/output (I/O) usage, and/or network usage of the target information handling system; deploy an initial set of one or more workload units to the target information handling system, wherein the one or more workload units are configured to cause an actual utilization level of processor, memory, I/O, and/or network resources on the target information handling system; and adjust the number of workload units deployed on the target information handling system in response to a mismatch between the target utilization levels and the actual 20 utilization levels.

In accordance with these and other embodiments of the present disclosure, a method may include an information handling system receiving a workload specification for a target information handling system, wherein the workload specification identifies target utilization levels for processor usage, memory usage, input/output (I/O) usage, and/or network usage of the target information handling system; the information handling system deploying an initial set of one or more workload units to the target information handling system, wherein the one or more workload units are configured to cause an actual utilization level of processor, memory, I/O, and/or network resources on the target information handling system; and the information handling system adjusting the number of workload units deployed on the target information handling system in response to a mismatch between the target utilization levels and the actual utilization levels.

In accordance with these and other embodiments of the present disclosure, an article of manufacture may include a non-transitory, computer-readable medium having computer-executable instructions thereon that are executable by an information handling system for: receiving a workload specification for a target information handling system, wherein the workload specification identifies target utilization levels for processor usage, memory usage, input/output (I/O) usage, and/or network usage of the target information handling system; deploying an initial set of one or more workload units to the target information handling system, wherein the one or more workload units are configured to cause an actual utilization level of processor, memory, I/O, and/or network resources on the target information handling system; and adjusting the number of workload units deployed on the target information handling system in response to a mismatch between the target utilization levels and the actual utilization levels.

Technical advantages of the present disclosure may be readily apparent to one skilled in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a block diagram of an example information handling system, in accordance with embodiments of the present disclosure; and

FIG. 2 illustrates an example architecture, in accordance with embodiments of the present disclosure.

### DETAILED DESCRIPTION

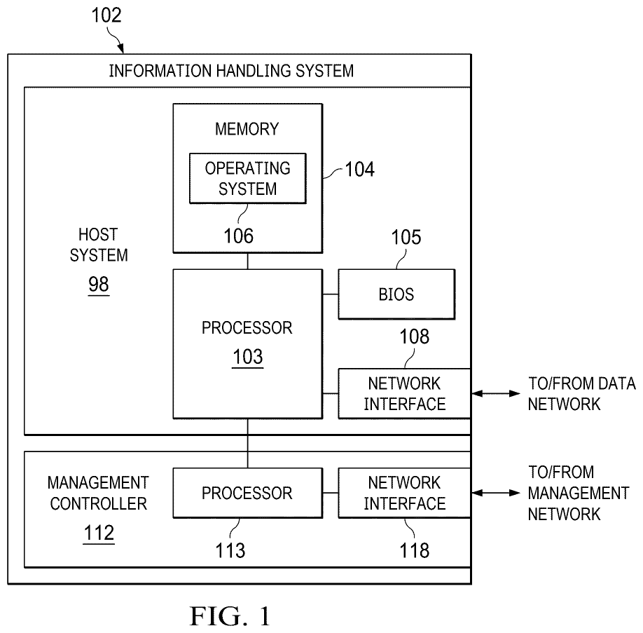

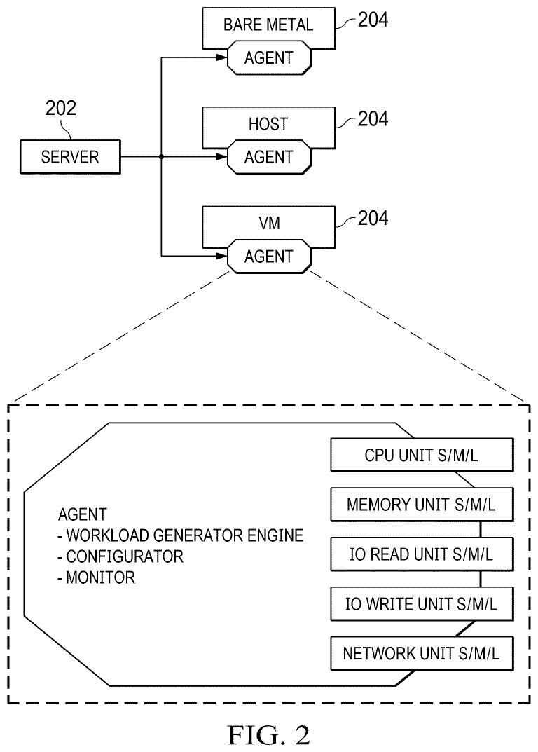

Preferred embodiments and their advantages are best understood by reference to FIGS. 1 and 2, wherein like numbers are used to indicate like and corresponding parts.

For the purposes of this disclosure, the term “information handling system” may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a (PDA), a consumer electronic personal digital assistant storage device, or any other suitable device, a network device and may vary in size, shape, performance, functionality, and price. The information handling system may include memory, one or more processing resources such as a central processing unit (“CPU”) or hardware or software control logic. Additional components of the information handling system may include one or more storage devices, one or more communications ports for communicating with external devices as well as various input/output (“I/O”) devices, such as a keyboard, a mouse, and a video display. The information handling system may also include one or more buses operable to transmit communication between the various hardware components.

For purposes of this disclosure, when two or more elements are referred to as “coupled” to one another, such term indicates that such two or more elements are in electronic communication or mechanical communication, as applicable, whether connected directly or indirectly, with or without intervening elements.

When two or more elements are referred to as “coupleable” to one another, such term indicates that they are capable of being coupled together.

For the purposes of this disclosure, the term “computer-readable medium” (e.g., transitory or non-transitory computer-readable medium) may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; communications media such as wires, optical fibers, microwaves, radio waves, and other electromagnetic and/or optical carriers; and/or any combination of the foregoing.

For the purposes of this disclosure, the term “information handling resource” may broadly refer to any component system, device, or apparatus of an information handling system, including without limitation processors, service processors, basic input/output systems, buses, memories, I/O devices and/or interfaces, storage resources, network interfaces, motherboards, and/or any other components and/or elements of an information handling system.

For the purposes of this disclosure, the term “management controller” may broadly refer to an information handling system that provides management functionality (typically out-of-band management functionality) to one or more other information handling systems. In some embodiments, a management controller may be (or may be an integral part of) a service processor, a baseboard management controller (BMC), a chassis management controller (CMC), or a remote access controller (e.g., a Dell Remote Access Controller (DRAC) or Integrated Dell Remote Access Controller (iDRAC)).

FIG. 1 illustrates a block diagram of an example information handling system 102, in accordance with embodiments of the present disclosure. In some embodiments, information handling system 102 may comprise a server chassis configured to house a plurality of servers or “blades.” In other embodiments, information handling system 102 may comprise a personal computer (e.g., a desktop computer, laptop computer, mobile computer, and/or notebook computer). In yet other embodiments, information handling system 102 may comprise a storage enclosure configured to house a plurality of physical disk drives and/or other computer-readable media for storing data (which may generally be referred to as “physical storage resources”). As shown in FIG. 1, information handling system 102 may comprise a processor 103, a memory 104 communicatively coupled to processor 103, a BIOS 105 (e.g., a UEFI BIOS) communicatively coupled to processor 103, a network interface 108 communicatively coupled to processor 103, and a management controller 112 communicatively coupled to processor 103.

In operation, processor 103, memory 104, BIOS 105, and network interface 108 may comprise at least a portion of a host system 98 of information handling system 102. In addition to the elements explicitly shown and described, information handling system 102 may include one or more other information handling resources.

Processor 103 may include any system, device, or apparatus configured to interpret and/or execute program instructions and/or process data, and may include, without limitation, a microprocessor, microcontroller, digital signal processor (DSP), application specific integrated circuit (ASIC), or any other digital or analog circuitry configured to interpret and/or execute program instructions and/or process data. In some embodiments, processor 103 may interpret and/or execute program instructions and/or process data stored in memory 104 and/or another component of information handling system 102.

Memory 104 may be communicatively coupled to processor 103 and may include any system, device, or apparatus configured to retain program instructions and/or data for a period of time (e.g., computer-readable media). Memory 104 may include RAM, EEPROM, a PCMCIA card, flash memory, magnetic storage, opto-magnetic storage, or any suitable selection and/or array of volatile or non-volatile memory that retains data after power to information handling system 102 is turned off.

As shown in FIG. 1, memory 104 may have stored thereon an operating system 106. Operating system 106 may comprise any program of executable instructions (or aggregation of programs of executable instructions) configured to manage and/or control the allocation and usage of hardware resources such as memory, processor time, disk space, and input and output devices, and provide an interface between such hardware resources and application programs hosted by operating system 106. In addition, operating system 106 may include all or a portion of a network stack for network communication via a network interface (e.g., network interface 108 for communication over a data network). Although operating system 106 is shown in FIG. 1 as stored in memory 104, in some embodiments operating system 106 may be stored in storage media accessible to processor 103, and active portions of operating system 106 may be transferred from such storage media to memory 104 for execution by processor 103.

Network interface 108 may comprise one or more suitable systems, apparatuses, or devices operable to serve as an interface between information handling system 102 and one or more other information handling systems via an in-band network. Network interface 108 may enable information handling system 102 to communicate using any suitable transmission protocol and/or standard. In these and other embodiments, network interface 108 may comprise a network interface card, or “NIC.” In these and other embodiments, network interface 108 may be enabled as a local area network (LAN)-on-motherboard (LOM) card.

Management controller 112 may be configured to provide management functionality for the management of information handling system 102. Such management may be made by management controller 112 even if information handling system 102 and/or host system 98 are powered off or powered to a standby state. Management controller 112 may include a processor 113, memory, and a network interface 118 separate from and physically isolated from network interface 108.

As shown in FIG. 1, processor 113 of management controller 112 may be communicatively coupled to processor 103. Such coupling may be via a Universal Serial Bus (USB), System Management Bus (SMBus), and/or one or more other communications channels.

Network interface 118 may be coupled to a management network, which may be separate from and physically isolated from the data network as shown. Network interface 118 of management controller 112 may comprise any suitable system, apparatus, or device operable to serve as an interface between management controller 112 and one or more other information handling systems via an out-of-band management network. Network interface 118 may enable management controller 112 to communicate using any suitable transmission protocol and/or standard. In these and other embodiments, network interface 118 may comprise a network interface card, or “NIC.” Network interface 118 may be the same type of device as network interface 108, or in other embodiments it may be a device of a different type.

As discussed above, embodiments of this disclosure may be used to provide benchmarking and load testing as a cloud-based service for information handling systems such as HCI clusters. FIG. 2 illustrates an example architecture diagram.

A server information handling system 202 provides cloud services to a plurality of client information handling systems 204. A workload agent may be provided to the client systems 204 by information handling system 202 and run locally thereon.

At a high level, the architecture of FIG. 2 may operate as follows. A user may provide a workload specification to server 202. The workload specification may indicate the desired amount of compute, memory, I/O, and/or network utilization for the test workload, as well as a desired duration for the testing. Server 202 may then deploy an agent onto the target client system 204, which may be executed to run the desired workload and continuously perform any adjustments necessary during runtime to cause the actual workload to match the specification (e.g., by starting or stopping workload units). Information regarding the numbers and types of running workload units and their performance characteristics may then be returned to server 202.

FIG. 2 also provides a detail view of the workload agent, which may be configured to deploy combinations of several different types of workload units. As shown, many different types s of workload units may be available, targeting CPU usage, memory usage, I/O reads, I/O writes, and network usage. Each type of workload unit may also be available in small, medium, and large sizes. By combining specific workload units of specific sizes, the agent may push the system utilization in each usage area to the desired levels. (For example, two large CPU units may provide less than the desired utilization, while three large CPU workload units may be too much. The agent may thus deploy two large CPU workload units and one small CPU workload unit.)

The agent itself may be deployed as a system service, as a containerized application, or in any other suitable fashion. Each workload unit may be implemented as a runnable program configured to introduce one kind of workload, as shown in FIG. 2. The agent may also save the mapping relationship between system resource usage requirements and the numbers and types of running units that meet those requirements, returning this information to the server as a strategy for future usage for when the same or similar workload is requested to be run on the same or similar hardware.

In some cases, it may be desirable to obtain performance benchmarking, temperature information, and other operational telemetry about a system at different workloads (e.g., at CPU utilization of 20%, 40%, 60%, and 80%; at memory utilization of 20%, 40%, 60%, and 80%; etc.). Thus a user may input the desired usage specifications into an interface of the cloud workload-as-a-service provider. The provider may then deploy a workload agent to each of the target nodes of an information handling system 204.

If there is a preexisting workload strategy targeting the desired workload specifications, that strategy may be used. If not, then the agent may use heuristics about the hardware configuration, the current load level, and other factors to come up with an initial prediction about what workload units to deploy. That prediction may be refined over time based on the actual usage that the deployed workload units are causing.

For instance, suppose a user wanted to simultaneously target a CPU usage of 20% (which is assumed to be equivalent to 2000 MHz of usage of a particular CPU having some standardized performance level) and 20% memory usage (32 GB). The agent may start with an initial set of workload units as shown in Table 1 below to approximate those usage requirements. In some embodiments, the agent may prefer to start up combinations of all three unit sizes to allow for easier adjustments.

Alternatively, if a preexisting strategy for the requested workload on similar hardware is available, that strategy may be implemented via the same workload units specified by that strategy, without the need for heuristics.

TABLE 1

| | Estimated Usage | | Number of Units to |
|---|---|---|---|
| | Per Unit | | Run |
| CPU unit - Large | 500 | MHz | 3 |
| CPU unit - Medium | 200 | MHz | 2 |
| CPU unit - Small | 50 | MHz | 2 |
| Memory unit - Large | 1 | GB | 30 |
| Memory unit - Medium | 500 | MB | 3 |
| Memory unit - Small | 100 | MB | 5 |

After starting up the initial set of workload units (either based on heuristics or based on a preexisting strategy), the agent may monitor the CPU and memory usage for a pre-configured period of time. Based on the actual usage levels observed, the agent may make adjustments as needed to start more units or stop some of the existing units to achieve a better fit to the requested load specifications.

After the workload has been run for the pre-configured period of time, the user may request other workloads, which may proceed in a similar fashion. Information handling system 202 may monitor performance, temperature, and any other operational characteristics during the testing, providing results to the user.

This disclosure encompasses all changes, substitutions, variations, alterations, and modifications to the exemplary embodiments herein that a person having ordinary skill in the art would comprehend. Similarly, where appropriate, the appended claims encompass all changes, substitutions, variations, alterations, and modifications to the exemplary embodiments herein that a person having ordinary skill in art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

Further, reciting in the appended claims that a structure is “configured to” or “operable to” perform one or more tasks is expressly intended not to invoke 35 U.S.C. § 112(f) for that claim element. Accordingly, none of the claims in this application as filed are intended to be interpreted as having means-plus-function elements. Should Applicant wish to invoke § 112(f) during prosecution, Applicant will recite claim elements using the “means for [performing a function]” construct.

All examples and conditional language recited herein are intended for pedagogical objects to aid the reader in understanding the invention and the concepts contributed by the inventor to furthering the art, and are construed as being without limitation to such specifically recited examples and conditions. Although embodiments of the present inventions have been described in detail, it should be understood that various changes, substitutions, and alterations could be made hereto without departing from the spirit and scope of the disclosure.

What is claimed is:

1. An information handling system comprising:
at least one processor; and
a memory;
wherein the information handling system is configured to:
receive a workload specification for a target information handling system, wherein the workload specification identifies target utilization levels for processor usage, memory usage, input/output (I/O) usage, and/or network usage of the target information handling system;
deploy an initial set of one or more workload units to the target information handling system, wherein the one or more workload units are configured to cause an actual utilization level of processor, memory, I/O, and/or network resources on the target information handling system; and
adjust the number of workload units deployed on the target information handling system in response to a mismatch between the target utilization levels and the actual utilization levels.

2. The information handling system of claim 1, wherein the one or more workload units comprise executable programs.

3. The information handling system of claim 1, wherein the initial set of one or more workload units is based on heuristics regarding a hardware configuration of the target information handling system.

4. The information handling system of claim 1, wherein the initial set of one or more workload units is based on a preexisting strategy from prior workload testing.

5. The information handling system of claim 1, wherein the information handling system is configured to store information regarding the adjusted number of workload units as a strategy for future workload testing.

6. The information handling system of claim 1, wherein the information handling system is configured to receive telemetry information from the target information handling system, the telemetry information including at least one temperature measurement.

7. A method comprising:
an information handling system receiving a workload specification for a target information handling system, wherein the workload specification identifies target utilization levels for processor usage, memory usage, input/output (I/O) usage, and/or network usage of the target information handling system;
the information handling system deploying an initial set of one or more workload units to the target information handling system, wherein the one or more workload units are configured to cause an actual utilization level of processor, memory, I/O, and/or network resources on the target information handling system; and
the information handling system adjusting the number of workload units deployed on the target information handling system in response to a mismatch between the target utilization levels and the actual utilization levels.

8. The method of claim 7, wherein the one or more workload units comprise executable programs.

9. The method of claim 7, wherein the initial set of one or more workload units is based on heuristics regarding a hardware configuration of the target information handling system.

10. The method of claim 7, wherein the initial set of one or more workload units is based on a preexisting strategy from prior workload testing.

11. The method of claim 7, further comprising the information handling system storing information regarding the adjusted number of workload units as a strategy for future workload testing.

12. The method of claim 7, further comprising the information handling system receiving telemetry information from the target information handling system, the telemetry information including at least one temperature measurement.

13. An article of manufacture comprising a non-transitory, computer-readable medium having computer-executable instructions thereon that are executable by an information handling system for:
receiving a workload specification for a target information handling system, wherein the workload specification identifies target utilization levels for processor usage, memory usage, input/output (I/O) usage, and/or network usage of the target information handling system;
deploying an initial set of one or more workload units to the target information handling system, wherein the one or more workload units are configured to cause an actual utilization level of processor, memory, I/O, and/or network resources on the target information handling system; and
adjusting the number of workload units deployed on the target information handling system in response to a mismatch between the target utilization levels and the actual utilization levels.

14. The article of claim 13, wherein the one or more workload units comprise executable programs.

15. The article of claim 13, wherein the initial set of one or more workload units is based on heuristics regarding a hardware configuration of the target information handling system.

16. The article of claim 13, wherein the initial set of one or more workload units is based on a preexisting strategy from prior workload testing.

17. The article of claim 13, wherein the instructions are further executable for storing information regarding the adjusted number of workload units as a strategy for future workload testing.

18. The article of claim 13, wherein instructions are further executable for receiving telemetry information from the target information handling system, the telemetry information including at least one temperature measurement.
